(19) United States
(12) Patent Application Publication
(10) Pub. No.: US 2025/0225278 A1
(43) Pub. Date: Jul. 10, 2025

(54) PREVENTING UNAUTHORIZED FINE-TUNING OF MACHINE LEARNING MODELS

(71) Applicant: QUALCOMM Incorporated, San Diego, CA (US)

(72) Inventors: Kyuhong SHIM, Seoul (KR); Seunghan YANG, Incheon (KR); Hyunsin PARK, Gwangmyeong (KR); Joo Seong JEONG, Seoul (KR)

(21) Appl. No.: 18/409,380

(22) Filed: Jan. 10, 2024

(51) Int. Cl. G06F 21/62; G06F 21/60

(52) U.S. Cl. CPC G06F 21/629; G06F 21/602

(57) ABSTRACT

Systems and techniques are described herein for using one or more machine learning models. For example, a computing device can receive one or more inputs for processing by a trained machine learning model. The trained machine learning model includes a trap function and/or trap parameters configured to be activated based on unauthorized fine-tuning of the trained machine learning model. The computing device can process the one or more inputs using the trained machine learning model to generate a model output. The computing device can then output the model output.

### FIELD

The present disclosure generally relates to preventing fine-tuning of machine learning models. For example, aspects of the present disclosure relate to systems and techniques for processing data using one or more machine learning models having at least one of a trap function or trap parameters for preventing unauthorized fine-tuning of the machine learning models.

### BACKGROUND

Many companies have developed machine learning models for a wide variety of different use cases, including chat bots, image segmentation, extended reality, autonomous vehicles, robotic systems, and many others. These machine learning models can be commercial or non-commercial. Furthermore, these machine learning models are becoming increasingly accessible as corporations and developers make the models available for use and, in some instances, further development. For example, some corporations are providing open-sourced machine learning models to developers for both commercial and non-commercial use.

However, the increasing availability and accessibility of these machine learning models result in less control over these models. For example, developers of the models may want to prevent usage of their models for illegal and/or inappropriate purposes. However, the developers may have limited control of users who utilize and subsequently modify the models.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for preventing fine-tuning of machine learning models. According to some examples, an apparatus for processing data using one or more machine learning models is provided. The apparatus includes at least one memory and at least one processor coupled to the at least one memory, the at least one processor configured to: receive one or more inputs for processing by a trained machine learning model, the trained machine learning model comprising at least one of a trap function or trap parameters configured to be activated based on unauthorized fine-tuning of the trained machine learning model; process the one or more inputs using the trained machine learning model to generate a model output; and output the model output.

In another illustrative example, a method for processing data using one or more machine learning models is provided. The method includes: receiving one or more inputs for processing by a trained machine learning model, the trained machine learning model comprising at least one of a trap function or trap parameters configured to be activated based on unauthorized fine-tuning of the trained machine learning model; processing the one or more inputs using the trained machine learning model to generate a model output; and outputting the model output.

In another illustrative example, a non-transitory computer-readable storage medium is provided including instructions stored thereon which, when executed by at least one processor, cause the at least one processor to: receive one or more inputs for processing by a trained machine learning model, the trained machine learning model comprising at least one of a trap function or trap parameters configured to be activated based on unauthorized fine-tuning of the trained machine learning model; process the one or more inputs using the trained machine learning model to generate a model output; and output the model output.

In another illustrative example, an apparatus is provided for processing data using one or more machine learning models. The apparatus includes: means for means for receiving one or more inputs for processing by a trained machine learning model, the trained machine learning model comprising at least one of a trap function or trap parameters configured to be activated based on unauthorized fine-tuning of the trained machine learning model; means for processing the one or more inputs using the trained machine learning model to generate a model output; and means for outputting the model output.

In some aspects, one or more of apparatuses described herein include a mobile device (e.g., a mobile telephone or so-called “smart phone” or other mobile device), a wireless communication device, a vehicle or a computing device, system, or component of the vehicle, an extended reality device (e.g., a virtual reality (VR) device, an augmented reality (AR) device, or a mixed reality (MR) device), a wearable device, a personal computer, a laptop computer, a server computer, a camera, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SoC), in accordance with some examples.

FIG. 2A illustrates an example of a fully connected neural network, in accordance with some examples.

FIG. 2B illustrates an example of a locally connected neural network, in accordance with some examples.

FIG. 2C illustrates an example of a convolutional neural network, in accordance with some examples.

FIG. 3 is a block diagram illustrating an example of a deep learning network, in accordance with some examples.

FIG. 4 is a block diagram illustrating an example of a convolutional neural network, in accordance with some examples.

FIG. 5 illustrates an example machine learning model having a trap function, in accordance with some examples.

FIG. 6 illustrates an example machine learning model having one or more trap parameters, in accordance with some examples.

FIG. 7 illustrates an example process for processing data using one or more machine learning models, in accordance with some examples.

FIG. 8 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides exemplary aspects and examples only, and is not intended to limit the scope, applicability, or configuration of the disclosure. Rather, the ensuing description of the exemplary aspects and examples will provide those skilled in the art with an enabling description for implementing aspects and examples of the disclosure. It should be understood that various changes may be made in the function and arrangement of elements without departing from the scope of the application as set forth in the appended claims.

As noted above, machine learning models have been developed for a wide variety of use cases, including chat bots, image segmentation, extended reality, autonomous vehicles, robotic systems, and many others. Machine learning models have been developed for both commercial and non-commercial purposes. Machine learning models are becoming increasingly accessible as corporations and developers make the models available for use and, in some instances, further development. For example, some corporations are providing open-sourced machine learning models to developers for both commercial and non-commercial use.

However, the increasing availability and accessibility of machine learning models result in less control over the models. For example, developers of machine learning models may want to prevent usage of their models for illegal and/or inappropriate purposes. However, the developers may have limited control over users who utilize and subsequently modify the models.

In addition to preventing illegal and/or inappropriate usage, companies and developers may desire to have more control over their models for other reasons. In some instances, some developers may allow usage of their models only for non-commercial uses. In some cases, some developers may prefer to monetize or require licenses for commercial uses of their models. In some instances, developers may allow users to freely use their models, but restrict modifications to their models.

Control over machine learning models is particularly difficult for some models, such as open-source models. For instance, companies and developers may open-source machine learning models (referred to as open-source models) to allow more users to use and modify the open-source models. For example, a company or developer may fine-tune a machine learning model of another company, open source or not, based on their own data and desired tasks. Fine-tuning of a machine learning model includes further training a previously trained machine learning model to modify parameters (e.g., weights) of the machine learning model, such as to perform a specific task (e.g., object detection for vehicle systems). For example, it can be challenging to generically develop machine learning models to perform as accurately and efficiently as a specialized machine learning model. Fine-tuning of machine learning models can improve performance of a generically trained machine learning models by specializing the models for particular environments, domains, and/or tasks. For example, a generic language model can be fine-tuned based on data representing previous conversations with a particular end user in order to personalize and/or adapt the model to the end user.

Despite the benefits of allowing fine-tuning of machine learning models, companies and developers may still want to maintain control over their models in certain cases, such as to prevent machine learning models from being fine-tuned for unintended user and/or for malintent.

Systems, apparatuses, processes (also referred to as methods), and computer-readable media (collectively referred to as “systems and techniques”) are described herein for preventing unauthorized fine-tuning and/or modifications of machine learning models. In some cases, a machine learning model can include one or more trap functions and/or one or more trap parameters that can prevent unauthorized fine-tuning of the machine learning model (or to prevent any fine-tuning of the model). The trap function(s) and the trap parameter(s) can be used individually or in combination to prevent unauthorized fine-tuning. Such an approach provides a dynamic strategy for protecting a machine learning model from unauthorized fine-tuning.

As noted above, one or more trap functions can be included in a machine learning model to prevent fine-tuning of the machine learning model. For example, a trap function can be configured to process an input parameter (also referred to as a function input) to generate a function output. The input parameter is set to a particular default value for inference of the machine learning model. When processed by the trap function, the default value will cause the trap function to output a default output value as the function output. The default output value can then be multiplied by a model parameter value (e.g., a constant value) to generate a default model parameter value. The default model parameter value can be used to process an input to a layer of the machine learning model (e.g., a convolutional layer) to generate an output of the layer (e.g., a value for a feature map).

However, if the machine learning model is fine-tuned, the input parameter will be tuned to a value other than the default value. When the input parameter includes a value other than the default value, the trap function will output a value (referred to as an invalid value) other than the default output value as the function output. The invalid value will be multiplied by the model parameter value (e.g., the constant) and will result in an invalid model parameter value. Processing the input to the layer of the machine learning model (e.g., the convolutional layer) using the invalid model parameter value will result in an output of the layer (e.g., a value for a feature map) that is invalid (e.g., which will result in degradation of performance of the machine learning model). In some cases, a trap function can be used for multiple model parameters (e.g., weights) of the machine learning model.

As further noted above, one or more trap parameters can be included in a machine learning model to prevent fine-tuning of the machine learning model. In some instances, trap parameters can be trained/tuned using an adversarial loss, which causes the trap parameters to degrade performance of the machine learning model when applied to an input to the machine learning model. However, a feature mask can be used mask out the trap parameters (e.g., rendering the trap parameters ineffective during fine-tuning), so that performance of the machine learning model is not degraded when used in an authorized manner. For example, the feature mask can include small values (e.g., values of 0) that are multiplied by the values of the trap parameters, rendering them ineffective in degrading the performance of the machine learning model. An authorization key can be used to provide authorized users with access to the mask (e.g., to decrypt the feature mask). An unauthorized user will not have access to the authorization key, and thus will not have the ability to use the feature mask to mask out the values of the trap parameters.

Various aspects of the present disclosure will be described with respect to the figures.

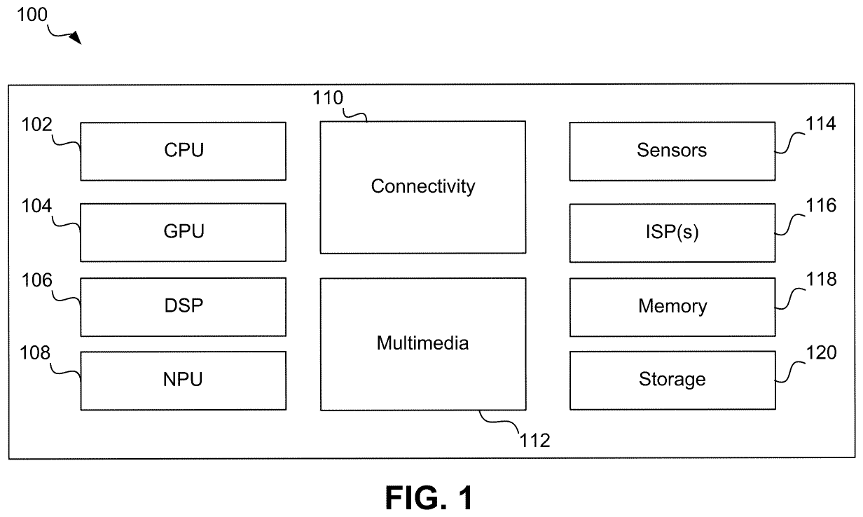

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, sparse generative neural networks (SG-NN), among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

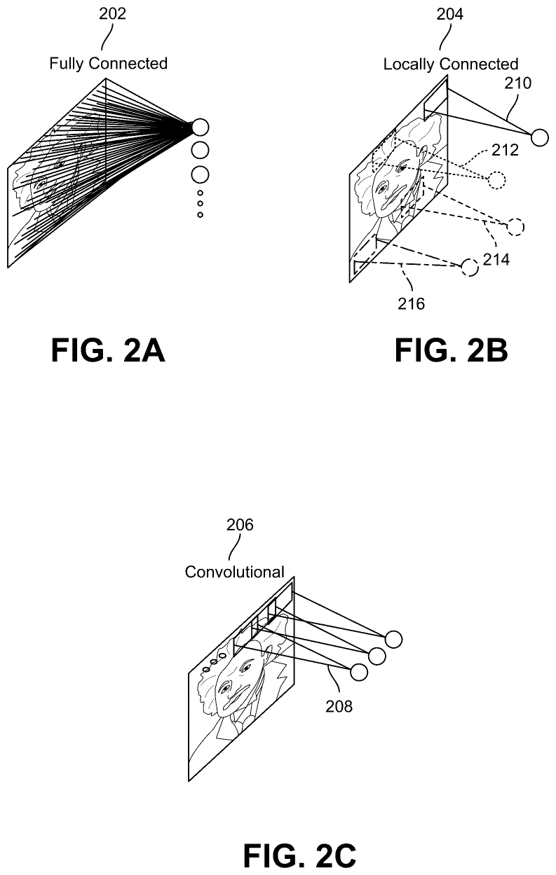

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

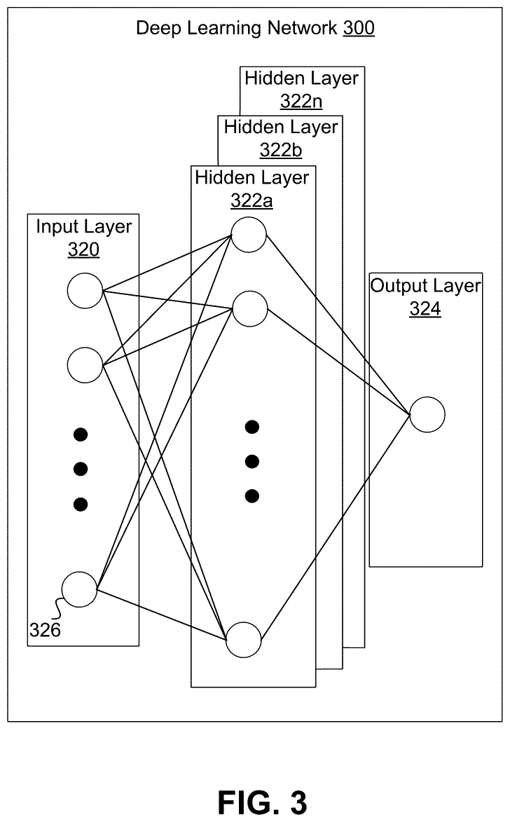

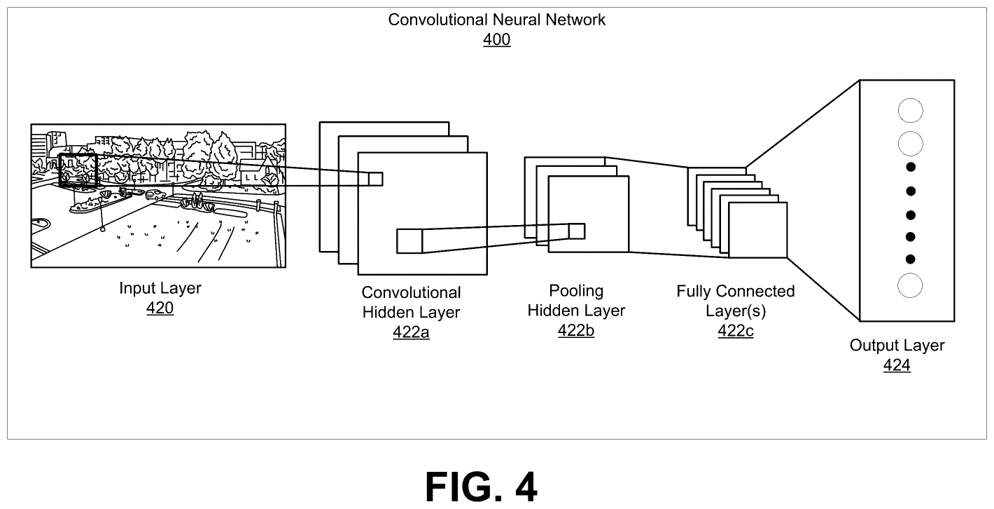

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 3. An illustrative example of a convolutional neural network is described in greater depth with respect to the example block diagram of FIG. 4.

FIG. 3 is an illustrative example of a deep learning neural network 300 that can be used by a machine learning model. An input layer 320 includes input data. In some examples, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some examples, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 300 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network, and the neural network 300 can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 300 can include any suitable deep network. As described previously, an example of a neural network 300 includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422b, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every bounding region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image. The pooling function can then discard the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class. The fully connected layer 422c can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As discussed above, some companies or developers may prefer to control how their machine learning models are used after deployment. As further discussed above, systems and techniques are described herein that include one or more trap functions and/or one or more trap parameters in a trained machine learning model to prevent unauthorized modifications to the trained machine learning model after deployment. These trap functions and/or trap parameters can be activated based on unauthorized fine-tuning or other modifications to the trained machine learning model.

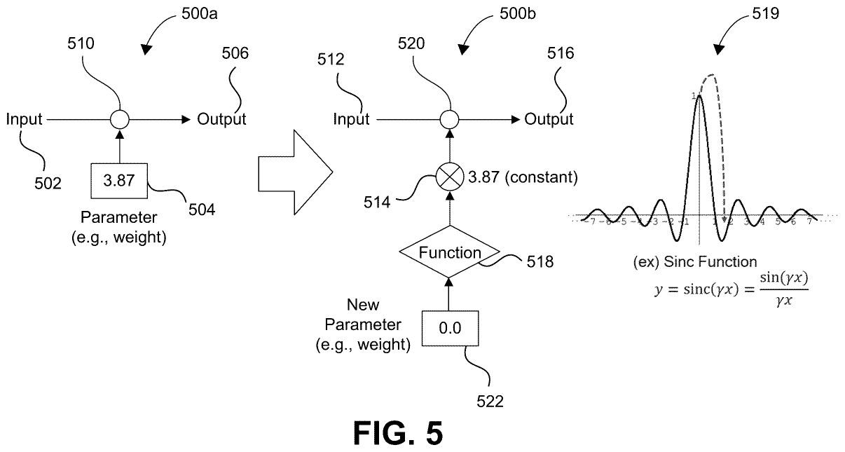

FIG. 5 illustrates an example of a trained machine learning model 500a configured to receive one or more model inputs 502, process the one or more model inputs 502 using an operation 510 (e.g., a convolution filter of a convolution layer or a different operation by another type of hidden layer as described above with respect to FIG. 3, and/or some other function) using a model parameter 504, and generate a model output 506. The model parameter 504 may include a weight that is tuned during training of the machine learning model 500a.

A machine learning model 500b is also illustrated in FIG. 5. The machine learning model 500b is similar to the machine learning model 500a, but the machine learning model 500b is modified to include a trap function 518. In some instances, the trap function 518 can be inserted into the machine learning model 500b after the initial training of the machine learning model 500b to prevent unintended (or intended) modification of the machine learning model 500b. As described herein, the machine learning model 500b is configured to maintain the same output based on the same input as the machine learning model 500a, but with a different computational flow. For example, the machine learning model 500b can receive one or more model inputs 512, process the one or more model inputs 512 using an operation 520 that includes a model parameter 514, and generate a model output 516. In various aspects, the model parameter 514 may be based on the trap function 518. The operation 520 can include any type of hidden layer (e.g., one or more of the hidden layers discussed above with respect to FIG. 3) that processes inputs (e.g., model inputs 512) and generates an output (e.g., model output 516). For example, the operation 520 may include a convolutional filter and the model parameter 514 may include a constant that is used as a weight (e.g., a non-tunable weight) of the convolutional filter. In the example of FIG. 5, the model parameter 514 is a constant value of 3.87. As described herein, the model parameter 514 can be modified based on a function output of the trap function 518 before the model parameter 514 is used to process the input 512.

As shown, a trap function input 522 is provided to the trap function 518. The trap function 518 puts the machine learning model 500b into an unstable equilibrium, such that even a small change in the trap function input 522 (e.g., caused by unauthorized fine-tuning, backpropagation, etc.) can cause failure or degradation of performance by the machine learning model 500b. The trap function input 522 is a trainable parameter that can be updated during fine-tuning of the machine learning model 500b. For example, the trap function input 522 is set to an initial or default value when the machine learning model 500b is deployed for inference. During fine-tuning of the machine learning model 500b, the trap function input 522 can be tuned from the initial or default input value to a different value.

The trap function 518 can be configured to provide a default output (e.g., a default value of 1) when the trap function input 522 is the initial or default input value. However, when the trap function input 522 is changed from the initial or default input value (e.g., based on fine-tuning of the machine learning model 500b), the trap function 518 will output a value (referred to as an invalid value) other than the default output value.

In the example of FIG. 5, the model parameter 514 (e.g., the constant) has a value of 3.87. When the trap function input 522 is the initial or default input value (e.g., a default value of 0.0), the trap function 518 is configured to output a default output value that, when combined with the model parameter 514, maintains the value of the model parameter 514 as 3.87. By maintaining the value of the model parameter 514 as 3.87, during a forward pass or at inference, the machine learning model 500b will output the same model output 516 as the model output 506 of the machine learning model 500a. However, after one or more unauthorized backward passes (e.g., during fine-tuning, backpropagation, etc.), the value of the trap function input 522 will be changed (e.g., tuned to a different value other than the default value of 0.0). Such a change in the value of the trap function input 522 will cause the trap function 518 to generate a different value for the model parameter 514. The different model parameter 514 causes subsequent inferences by the machine learning model 500b to generate a different model output 516 from the original model output 506, which will result in unintended changes in performance. For example, an image classification model may begin to generate inaccurate classifications (e.g., model output 516) for objects in an image (e.g., model input 512) due to the changed model parameters 514.

In some aspects, as illustrated by the graph 519 of FIG. 5, the trap function 518 can be a sinc function. The sinc function has an equation of:

$$y = sin c ( γ x ) = \frac{sin ( γ x )}{γ x}$$

One benefit of the sinc function is that a small change of the x-axis can create a large change in the y-axis. For instance, a function input to the sinc function is changed by a first magnitude, the sinc function can change a function output of the since function by a second magnitude, where the second magnitude is larger than the first magnitude. For example, a small change to a model parameter value due to unauthorized fine-tuning or any other modification can create a significantly different output from the sinc function. Furthermore, it is challenging to return to the initial value after the change. For example, FIG. 5 illustrates that even relatively small change in the x-axis from the initial value of 0, will cause the y-axis to change from 1 to some other value and, in some instances, a negative value. Furthermore, any other x-values fail to return the original y-value of 1. FIG. 5 illustrates the trap function 518 being a sinc function for explanatory and discussion purposes only. One of ordinary skill in the art would understand that many other functions can be used as a trap function 518 to degrade performance of a machine learning model 500b during unauthorized modifications. The trap function 518 can include other types of functions other than a sinc function, such as a sine function, a cosine function, other oscillating functions, and/or other types of functions.

In some cases, multiple trap functions 518 may be included throughout the machine learning model 500b. For example, the machine learning model 500b can have multiple convolutional layers, with each convolutional layer (or at least some of the convolutional layers) having a trap function 518. For example, referring to FIG. 3, the neural network 300 includes multiple hidden layers 322a-322n. Each of the hidden layers 322a-322n and/or nodes thereof can have one or more trap functions 518, such that the activation functions performed by the hidden layer 322a-322n and/or node thereof are based on the model parameter 514 output by the trap function 518. By including multiple trap functions 518 throughout the machine learning model 500b, unauthorized modifications will cause changes to trap function inputs 522 for the multiple trap functions 518. Recovering all of the trap function inputs 522 to the original default values would be difficult, if not virtually impossible. Consequently, the trap functions 518 will output many different model parameters 514 and cause the machine learning model 500b to output significantly different model outputs 516 as compared to the intended output of the originally trained model. For example, after unauthorized modifications, trap function(s) 518 will significantly degrade the performance of the machine learning model 500b.

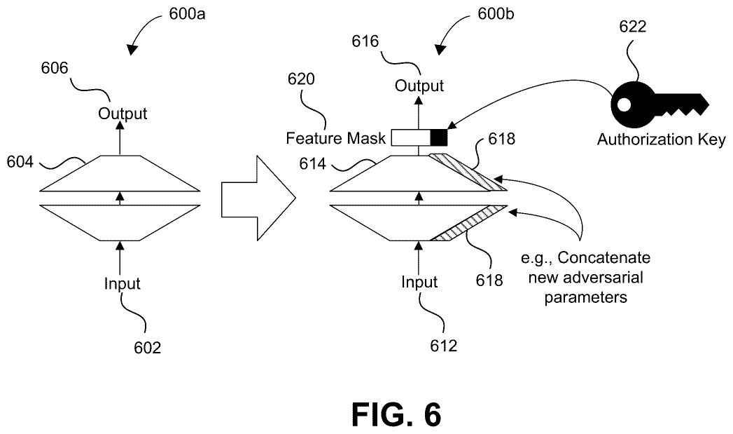

FIG. 6 is a diagram illustrating an examples of a machine learning model 600a and a machine learning model 600b. The machine learning model 600a is configured to receive one or more model inputs 602, process the one or more model inputs 602 using one or more model parameters 604 (e.g., in one or more layers, filters, and/or functions, such as a convolutional layer or filter), and generate a model output 606. The machine learning model 600a can be modified to include one or more trap parameters 618 in one or more layers of the machine learning model 600a, resulting in the machine learning model 600b. The machine learning model 600b can receive one or more model inputs 612, process the one or more model inputs 612 using model parameters 614 and trap parameters 618 (e.g., in one or more layers, filters, and/or functions, such as a convolutional layer or filter), and generate a model output 616.

The trap parameters 618 can be adversarial parameters that are trainable. Adversarial parameters are parameters that are configured to degrade performance of the machine learning model 600b when applied to the input 612. In some cases, the trap parameters 618 can be updated during future modifications and fine-tuning. For example, during unauthorized fine-tuning or other modification, the trap parameters 618 are trained along with the model parameters 614. Unauthorized modifications to the trap parameters 618 will increase an impact of the trap parameters 618, which can cause degradation, or even failure, of future performance of machine learning model 600b. For example, the trap parameters 618 can make future training of the machine learning model 600b fail, more unstable, less efficient, and/or more time-consuming.

In some embodiments, the trap parameters 618 can be inserted into the machine learning model 600a after initial training of the machine learning model 600a (resulting in machine learning model 600b) to avoid unintended modification of the trap parameters 618 during the initial training. For example, the trap parameters 618 can be added to one or more layers of the machine learning model 600a and an additional adversarial training can be performed using adversarial loss to train or tune the adversarial parameters, resulting in the machine learning model 600b. The adversarial loss is configured to refine the trap parameters 618 to reduce an accuracy of the machine learning model 600b. In some instances, the trap parameters 618 are added to existing layers of the machine learning model 600a to result in the machine learning model 600b. In some instances, the trap parameters 618 are added to newly added layers of the machine learning model 600a to result in the machine learning model 600b.

In some instances, a feature mask 620 can be included to distinguish the trap parameters 618 from the typical or normal model parameters 614. The feature mask 620 can be trainable, so that the trap parameters 618 can be updated when an unauthorized user updates all of the parameters (e.g., both the model parameters 614 and trap parameters 618). The feature mask 620 can be configured to mask or otherwise deactivate the trap parameters 618 from being trained or updated during future authorized training. In some instances, the feature mask 620 can be configured to set the trap parameters 618 to be ineffective by multiplying the trap parameters 618 with small values (e.g., values of 0) during the initial training and/or when further training (e.g., fine-tuning) is authorized. In some instances, the feature mask 620 is a binary mask that indicates which channels are associated with original channels including the model parameters 614 and which channels are associated with newly added channels including the adversarial or trap parameters 618. For example, values in the mask may indicate a 0 or 1 value, such that a value of 0 indicates an original channel and a value of 1 indicates an adversarial channel. When authorized, a user can use the feature mask to deactivate the adversarial channels (e.g., channels having a value of 1) during fine-tuning. Without the feature mask, the user will not be able to identify the adversarial channels and/or otherwise distinguish the adversarial channels from the normal, existing channels. Consequently, unauthorized modification of the machine learning model 600b will modify the adversarial or trap parameters 618 during fine-tuning or any other modification of the machine learning model 600b, which will corrupt the output and/or degrade performance of the machine learning model 600b.

In some cases, an authorization key 622 can be used to provide authorized users with access to the mask (e.g., to decrypt the values of the feature mask) in order to access the information in the mask indicating which features should be masked or otherwise deactivated during training (e.g., during fine-tuning). For example, in some instances, the feature mask 620 can be encrypted and the authorization key 622 can provide an encryption key that can be used to decrypt the values of the feature mask 620 and obtain correct values for the feature mask 620 (e.g., to determine which features or channels to deactivate or otherwise disregard during authorized modification of the machine learning model 600b). For example, the feature mask 620 may be encrypted using a secure hashing algorithm (SHA) and the authorization key 622 facilitates decryption of the feature mask 620.

The authorization key 622 can be provided to authorized users, so that the authorized users can perform acceptable, authorized, and/or permitted modifications to the machine learning model 600b. For example, an authorized user may purchase a license from the developer of the machine learning model 600b. As another example, the authorized user may be a third party verified by the developer. If a user does not have the authorization key, then the user cannot identify adversarial channels and will, thus, modify the adversarial or trap parameters 618 during fine-tuning, which will subsequently corrupt the output and performance of the machine learning model 600b.

Although not illustrated in FIG. 5, an authorization key and/or a feature mask can be used to identify the trap functions 518 of FIG. 5 and mask or otherwise deactivate the trap functions 518 and/or trap function inputs 522 during authorized training. Additionally, the trap functions 518 and trap parameters 618 can be used alone or in conjunction with each other in machine learning models.

The trap parameters 618 can be included in one or more layers of the machine learning model 600b. Referring again to FIG. 3, each of the hidden layers 322a-322n and/or nodes thereof can have one or more trap parameters 618, such that the activation functions performed by the hidden layer 322a-322n and/or node thereof use the model parameters 614 and the trap parameters 618. By including multiple trap parameters 618 throughout various layers of the machine learning model 600b, unauthorized modifications will cause multiple changes to the trap parameters 618, which can cause further degradation of the machine learning model 600b.

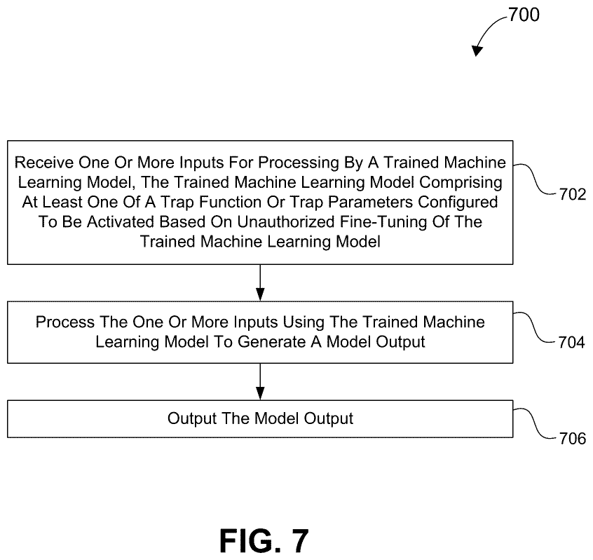

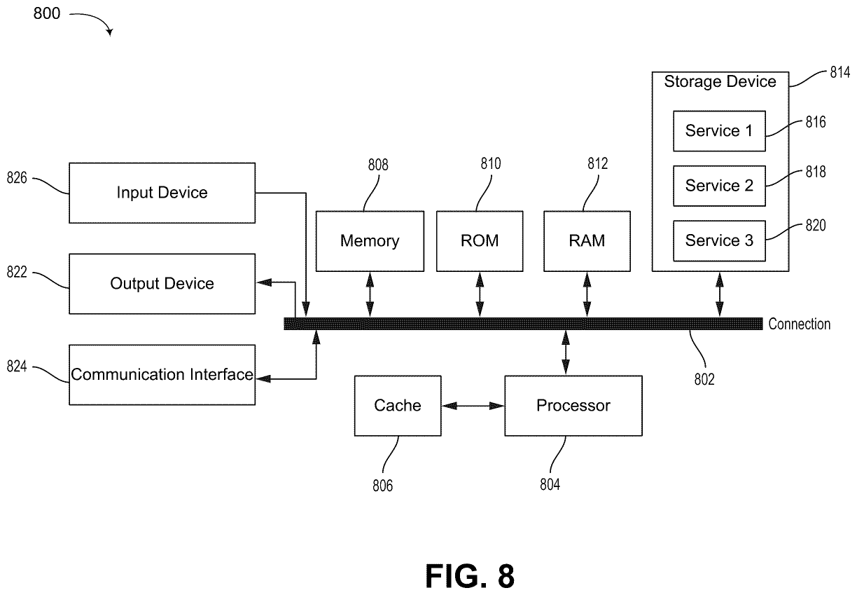

FIG. 7 is a flowchart illustrating an example process 700 for processing data using one or more machine learning models based on one or more of the techniques described herein. The process 700 can be performed by a computing device (or apparatus), or a component of a computing device (e.g., a chipset, one or more processors such as CPU(s), GPU(s), NPU(s), NSP(s), DSP(s), etc.), which may utilize or implement a machine learning model as described above. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the SOC 100 of FIG. 1, the computing system 800 of FIG. 8, and/or other computing device or apparatus.

Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

At block 702, the computing device (or component thereof) can receive one or more inputs (e.g., e.g., model inputs 502, 512, 602, and/or 612 of FIGS. 5 and 6) for processing by a trained machine learning model. The trained machine learning model can include or be part of the fully connected neural network 202 of FIG. 2A, the locally connected neural network 204 of FIG. 2B, the convolutional neural network of FIG. 2C, the neural network 300 of FIG. 3, the convolutional neural network 400 of FIG. 4, the trained machine learning model 500b of FIG. 5, and/or the machine learning model 600b of FIG. 6). The trained machine learning model includes a trap function (e.g., trap function 518 of FIG. 5) and/or trap parameters (e.g., the trap parameters 618 of FIG. 6). The trap function and the trap parameters are configured to be activated based on unauthorized fine-tuning of the machine learning model.

In some aspects, the trap function is configured to receive a function input and output a function output. The model output is based on the function output. In some examples, the trap function is configured to output a default value (e.g., a default value of 1, as shown in FIG. 5) as the function output based on the function input including a default parameter value (e.g., a default parameter value of 0.0, as shown in FIG. 5). In some cases, the trap function is configured to output an invalid value as the function output based on the function input including a value other than the default parameter value. In some examples, when the function input is changed by a first magnitude, the trap function is configured to change the function output by a second magnitude, with the second magnitude being larger than the first magnitude. For instance, in some aspects, the trap function is a sinc function (e.g., as illustrated by graph 519 of FIG. 5).

In some cases, the trap parameters of the trained machine learning model are adversarial parameters based on an adversarial loss used to train the trained machine learning model. For instance, the trained machine learning model can be trained using the adversarial loss to generate the trap parameters as adversarial parameters. In some cases, other losses can be used in addition to the adversarial loss, such as L1 loss (e.g., mean absolute error), an L2 loss (e.g., mean square error), cross entropy loss, any combination thereof, and/or other loss functions. Based on the adversarial loss, the trap parameters are configured to degrade performance of the trained machine learning model. In some examples, the trained machine learning model includes or provides a feature mask (e.g., the feature mask 620 of FIG. 6) configured to reduce an impact of the trap parameters during fine-tuning of the trained machine learning model. For example, the feature mask can mask the trap parameters during the fine-tuning. In some cases, the trap parameters remain unchanged during backpropagation based on the feature mask. In some aspects, the computing device (or component thereof) can receive an authorization key (e.g., authorization key 622 of FIG. 6). The computing device (or component thereof) can decrypt the feature mask using the authorization key.

At block 704, the computing device (or component thereof) can process the one or more inputs using the trained machine learning model to generate a model output (e.g., model output 506 of FIG. 5, model output 516 of FIG. 5, model output 606 of FIG. 6, and/or model output 616 of FIG. 6). The model output can include a feature map for processing by one or more subsequent machine learning layers (e.g., neural network layer(s)) or can include a final output of the machine learning model (e.g., a classification output, an object detection output, a semantic segmentation output, any combination thereof, and/or other type of output for which the machine learning model is trained to generate).

At block 706, the computing device (or component thereof) can output the model output.

As noted above, the methods and processes described herein (e.g., process 700 and/or any other process described herein) may be performed by a computing device or apparatus utilizing or implementing a machine learning model (e.g., the fully connected neural network 202 of FIG. 2A, the locally connected neural network 204 of FIG. 2B, the convolutional neural network 206 of FIG. 2C, the neural network 300 of FIG. 3, CNN 400 of FIG. 4, etc.). In some examples, the process 700 can be performed by the SOC 100 of FIG. 1. In another example, the process 700 can be performed by the computing system having the computing device architecture of the computing system 800 shown in FIG. 8. For instance, a computing device with the computing device architecture of the computing system 800 shown in FIG. 8 can implement the operations of FIG. 7 and/or the components and/or operations described herein with respect to any of FIG. 5 through FIG. 7.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the process 700 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 shows an example of computing system 800, which can be for example any computing device making up SOC 100, fully connected neural network 202, locally connected neural network 204, convolutional neural network 206, neural network 300, CNN 400, machine learning model 500b, machine learning model 600b, of FIGS. 2A-6, or any component thereof in which the components of the system are in communication with each other using connection 802. In some examples, the computing system 800 can perform the process 700 of FIG. 7. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processor 804 and connection 802 that couples various system components including system memory 808, such as read-only memory (ROM) 810 and random-access memory (RAM) 812 to processor 804. Computing system 800 can include a cache 806 (e.g., a cache of high-speed memory) connected directly with, in close proximity to, or integrated as part of processor 804.

Processor 804 can include any general-purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric. In some aspects, the processor 804 (in some cases in combination with one or more other components, such as the ROM 810 and/or RAM 812) can perform any of the techniques described herein, such as the techniques described with respect to the machine learning model 500b of FIG. 5, the machine learning model 600b of FIG. 6, and/or the process 700 of FIG. 7.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for processing data using one or more machine learning models, comprising: at least one memory; and at least one processor coupled to the at least one memory, the at least one processor configured to: receive one or more inputs for processing by a trained machine learning model, the trained machine learning model comprising at least one of a trap function or trap parameters configured to be activated based on unauthorized fine-tuning of the trained machine learning model; process the one or more inputs using the trained machine learning model to generate a model output; and output the model output.

Aspect 2. The apparatus of Aspect 1, wherein the trap function is configured to receive a function input and output a function output, and wherein the model output is based on the function output.

Aspect 3. The apparatus of Aspect 2, wherein the trap function is configured to output a default value as the function output based on the function input including a default parameter value.

Aspect 4. The apparatus of Aspect 3, wherein the trap function is configured to output an invalid value as the function output based on the function input including a value other than the default parameter value.

Aspect 5. The apparatus of any one of Aspects 2 to 4, wherein when the function input is changed by a first magnitude, the trap function is configured to change the function output by a second magnitude, wherein the second magnitude is larger than the first magnitude.

Aspect 6. The apparatus of any one of Aspects 1 to 5, wherein the trap function is a sinc function.

Aspect 7. The apparatus of any one of Aspects 1 to 6, wherein the trap parameters of the trained machine learning model are adversarial parameters based on an adversarial loss used to train the trained machine learning model, wherein the trap parameters are configured to degrade performance of the trained machine learning model.

Aspect 8. The apparatus of Aspect 7, wherein the trained machine learning model comprises a feature mask configured to reduce an impact of the trap parameters during fine-tuning of the trained machine learning model.

Aspect 9. The apparatus of Aspect 8, wherein the feature mask is configured to mask the trap parameters during the fine-tuning.

Aspect 10. The apparatus of any one of Aspects 8 to 9, wherein the trap parameters remain unchanged during backpropagation based on the feature mask.

Aspect 11. The apparatus of any one of Aspects 8 to 10, wherein the at least one processor is further configured to: receive an authorization key; and decrypt the feature mask using the authorization key.

Aspect 12. A processor-implemented method for processing data using one or more machine learning models, comprising: receiving one or more inputs for processing by a trained machine learning model, the trained machine learning model comprising at least one of a trap function or trap parameters configured to be activated based on unauthorized fine-tuning of the trained machine learning model; processing the one or more inputs using the trained machine learning model to generate a model output; and outputting the model output.

Aspect 13. The processor-implemented method of Aspect 12, wherein the trap function is configured to receive a function input and output a function output, and wherein the model output is based on the function output.

Aspect 14. The processor-implemented method of Aspect 13, wherein the trap function is configured to output a default value as the function output based on the function input including a default parameter value.

Aspect 15. The processor-implemented method of Aspect 14, wherein the trap function is configured to output an invalid value as the function output based on the function input including a value other than the default parameter value.

Aspect 16. The processor-implemented method of any one of Aspects 13 to 15, wherein when the function input is changed by a first magnitude, the trap function is configured to change the function output by a second magnitude, wherein the second magnitude is larger than the first magnitude.

Aspect 17. The processor-implemented method of any one of Aspects 12 to 16, wherein the trap function is a sinc function.

Aspect 18. The processor-implemented method of any one of Aspects 12 to 17, wherein the trap parameters of the trained machine learning model are adversarial parameters based on an adversarial loss used to train the trained machine learning model, wherein the trap parameters are configured to degrade performance of the trained machine learning model.

Aspect 19. The processor-implemented method of Aspect 18, wherein the trained machine learning model comprises a feature mask configured to reduce an impact of the trap parameters during fine-tuning of the trained machine learning model.

Aspect 20. The processor-implemented method of Aspect 19, wherein the feature mask is configured to mask the trap parameters during the fine-tuning.

Aspect 21. The processor-implemented method of any one of Aspects 19 to 20, wherein the trap parameters remain unchanged during backpropagation based on the feature mask.

Aspect 22. The processor-implemented method of any one of Aspects 19 to 21, further comprising: receiving an authorization key; and decrypting the feature mask using the authorization key.

Aspect 23. A non-transitory computer-readable medium having stored instructions that, when executed by one or more processors, cause the one or more processors to: receive one or more inputs for processing by a trained machine learning model, the trained machine learning model comprising at least one of a trap function or trap parameters configured to be activated based on unauthorized fine-tuning of the trained machine learning model; process the one or more inputs using the trained machine learning model to generate a model output; and output the model output.

Aspect 24. The non-transitory computer-readable medium of Aspect 23, wherein the trap function is configured to receive a function input and output a function output, and wherein the model output is based on the function output.

Aspect 25. The non-transitory computer-readable medium of Aspect 24, wherein the trap function is configured to output a default value as the function output based on the function input including a default parameter value.

Aspect 26. The non-transitory computer-readable medium of Aspect 25, wherein the trap function is configured to output an invalid value as the function output based on the function input including a value other than the default parameter value.

Aspect 27. The non-transitory computer-readable medium of any one of Aspects 24 to 26, wherein when the function input is changed by a first magnitude, the trap function is configured to change the function output by a second magnitude, wherein the second magnitude is larger than the first magnitude.

Aspect 28. The non-transitory computer-readable medium of any one of Aspects 23 to 27, wherein the trap function is a sinc function.

Aspect 29. The non-transitory computer-readable medium of any one of Aspects 23 to 28, wherein the trap parameters of the trained machine learning model are adversarial parameters based on an adversarial loss used to train the trained machine learning model, wherein the trap parameters are configured to degrade performance of the trained machine learning model.

Aspect 30. The non-transitory computer-readable medium of Aspect 29, wherein the trained machine learning model comprises a feature mask configured to reduce an impact of the trap parameters during fine-tuning of the trained machine learning model.

Aspect 31. The non-transitory computer-readable medium of Aspect 30, wherein the feature mask is configured to mask the trap parameters during the fine-tuning.

Aspect 32. The non-transitory computer-readable medium of any one of Aspects 30 to 31, wherein the trap parameters remain unchanged during backpropagation based on the feature mask.

Aspect 33. The non-transitory computer-readable medium of any one of Aspects 30 to 32, wherein the instructions, when executed by the one or more processors, further cause the one or more processors to: receive an authorization key; and decrypt the feature mask using the authorization key.

Aspect 34. An apparatus for processing data using one or more machine learning models, comprising: means for receiving one or more inputs for processing by a trained machine learning model, the trained machine learning model comprising at least one of a trap function or trap parameters configured to be activated based on unauthorized fine-tuning of the trained machine learning model; means for processing the one or more inputs using the trained machine learning model to generate a model output; and means for outputting the model output.

Aspect 35. The apparatus of Aspect 34, wherein the trap function is configured to receive a function input and output a function output, and wherein the model output is based on the function output.

Aspect 36. The apparatus of Aspect 35, wherein the trap function is configured to output a default value as the function output based on the function input including a default parameter value.

Aspect 37. The apparatus of Aspect 36, wherein the trap function is configured to output an invalid value as the function output based on the function input including a value other than the default parameter value.

Aspect 38. The apparatus of any one of Aspects 35 to 37, wherein when the function input is changed by a first magnitude, the trap function is configured to change the function output by a second magnitude, wherein the second magnitude is larger than the first magnitude.

Aspect 39. The apparatus of any one of Aspects 34 to 38, wherein the trap function is a sinc function.

Aspect 40. The apparatus of any one of Aspects 34 to 39, wherein the trap parameters of the trained machine learning model are adversarial parameters based on an adversarial loss used to train the trained machine learning model, wherein the trap parameters are configured to degrade performance of the trained machine learning model.

Aspect 41. The apparatus of Aspect 40, wherein the trained machine learning model comprises a feature mask configured to reduce an impact of the trap parameters during fine-tuning of the trained machine learning model.

Aspect 42. The apparatus of Aspect 41, wherein the feature mask is configured to mask the trap parameters during the fine-tuning.

Aspect 43. The apparatus of any one of Aspects 41 to 42, wherein the trap parameters remain unchanged during backpropagation based on the feature mask.

Aspect 44. The apparatus of any one of Aspects 41 to 43, further comprising: means for receiving an authorization key; and means for decrypting the feature mask using the authorization key.

What is claimed is:

1. An apparatus for processing data using one or more machine learning models, comprising:
at least one memory; and
at least one processor coupled to the at least one memory, the at least one processor configured to:
receive one or more inputs for processing by a trained machine learning model, the trained machine learning model comprising at least one of a trap function or trap parameters configured to be activated based on unauthorized fine-tuning of the trained machine learning model;
process the one or more inputs using the trained machine learning model to generate a model output; and
output the model output.

2. The apparatus of claim 1, wherein the trap function is configured to receive a function input and output a function output, and wherein the model output is based on the function output.

3. The apparatus of claim 2, wherein the trap function is configured to output a default value as the function output based on the function input including a default parameter value.

4. The apparatus of claim 3, wherein the trap function is configured to output an invalid value as the function output based on the function input including a value other than the default parameter value.

5. The apparatus of claim 2, wherein when the function input is changed by a first magnitude, the trap function is configured to change the function output by a second magnitude, wherein the second magnitude is larger than the first magnitude.

6. The apparatus of claim 1, wherein the trap function is a sinc function.

7. The apparatus of claim 1, wherein the trap parameters of the trained machine learning model are adversarial parameters based on an adversarial loss used to train the trained machine learning model, wherein the trap parameters are configured to degrade performance of the trained machine learning model.

8. The apparatus of claim 7, wherein the trained machine learning model comprises a feature mask configured to reduce an impact of the trap parameters during fine-tuning of the trained machine learning model.

9. The apparatus of claim 8, wherein the feature mask is configured to mask the trap parameters during the fine-tuning.

10. The apparatus of claim 8, wherein the trap parameters remain unchanged during backpropagation based on the feature mask.

11. The apparatus of claim 8, wherein the at least one processor is further configured to:
receive an authorization key; and
decrypt the feature mask using the authorization key.

12. A processor-implemented method for processing data using one or more machine learning models, the processor-implemented method comprising:
receiving one or more inputs for processing by a trained machine learning model, the trained machine learning model comprising at least one of a trap function or trap parameters configured to be activated based on unauthorized fine-tuning of the trained machine learning model;
processing the one or more inputs using the trained machine learning model to generate a model output; and
outputting the model output.

13. The processor-implemented method of claim 12, wherein the trap function is configured to receive a function input and output a function output, and wherein the model output is based on the function output.

14. The processor-implemented method of claim 13, wherein the trap function is configured to output a default value as the function output based on the function input including a default parameter value.

15. The processor-implemented method of claim 14, wherein the trap function is configured to output an invalid value as the function output based on the function input including a value other than the default parameter value.

16. The processor-implemented method of claim 12, wherein the trap function is a sinc function.

17. The processor-implemented method of claim 12, wherein the trap parameters of the trained machine learning model are adversarial parameters based on an adversarial loss used to train the trained machine learning model, wherein the trap parameters are configured to degrade performance of the trained machine learning model.

18. The processor-implemented method of claim 17, wherein the trained machine learning model comprises a feature mask configured to reduce an impact of the trap parameters during fine-tuning of the trained machine learning model, and wherein the feature mask is configured to mask the trap parameters during the fine-tuning.

19. The processor-implemented method of claim 18, further comprising:
receiving an authorization key; and
decrypting the feature mask using the authorization key.

20. A non-transitory computer-readable medium having stored instructions that, when executed by one or more processors, cause the one or more processors to:
receive one or more inputs for processing by a trained machine learning model, the trained machine learning model comprising at least one of a trap function or trap parameters configured to be activated based on unauthorized fine-tuning of the trained machine learning model;
process the one or more inputs using the trained machine learning model to generate a model output; and
output the model output.
